(19) United States
(12) Patent Application Publication
(10) Pub. No.: US 2006/0224300 A1
(43) Pub. Date: Oct. 5, 2006

(54) System and method for providing information of moving objects' states of move, location data collection system, and car navigation system

(76) Inventors: Makoto Shioya, Tokyo (JP); Satoshi Sugawara, Kimitsu (JP); Shuichi Miyazaki, Yokohama (JP); Naomichi Nonaka, Yokohama (JP); Kenichi Mitamura, Fujisawa (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/356,173

(22) Filed: Feb. 17, 2006

(30) Foreign Application Priority Data
Mar. 30, 2005 (JP) 2005-099585

(51) Int. Cl. G01C 21/00

(52) U.S. Cl. 701/200; 701/1; 701/210

(57) ABSTRACT

A mobile phone base station sends to a mobile phone device information requesting location data thereof, receives location data sent back by the mobile phone device according to the information, and outputs the location data to a location data collection system. The location data collection system inputs the location data, and generates state-of-move information constituted from a location distribution, a moving speed distribution, and a moving direction distribution, or information obtained by filing these information, based on the location data. Then, the location data collection system broadcasts the generated state-of-move information to the car navigation system located in a predetermined area through the mobile phone base station. The car navigation system displays the received state-of-move information on a screen of a display unit thereof with a map indicating the vicinity of the location of the vehicle.

### BACKGROUND OF THE INVENTION

The present invention relates to a system and a method for providing information of a moving object's state of move and a location data collection system, for providing to a car navigation system state-of-move information such as a location distribution, a moving speed distribution, or a moving direction distribution of a moving object including a pedestrian and the like, based on location data indicated by a wireless terminal device such as a mobile phone device. The invention also relates to the car navigation system.

In recent years, mobile phone devices have remarkably become widespread, so that two-third of a total population are said to carry mobile phone devices now. Some mobile phone devices include a positioning function using a GPS (Global Positioning System), for example, so that provision of a navigation system for a pedestrian or the like has already been commercialized. Further, an attempt to detect the location and the moving speed of the mobile phone device or a person carrying the mobile phone device, thereby utilizing the mobile phone device for traffic safety has also been started.

According to a technique disclosed in paragraphs 0015 to 0028, paragraphs 0032 to 0037, FIGS. 3 to 8 of JP-A-2004-157847, for example, when a person who is carrying a mobile phone device crosses a road at a pedestrian crossing or the like, the mobile phone device transmits to a car navigation system mounted on a vehicle information that the person is crossing the road. Then, when the crossing of the road by the pedestrian is performed in front of the vehicle, the car navigation system that has received the information issues to the driver of the vehicle an alarm indicating that there is the pedestrian who is crossing a road.

According to an example of a technique disclosed in this specification, the moving speed and the moving direction of the mobile phone device is obtained from location data obtained by the GPS. Further, by referring to the direction of a road obtained from map information, crossing of the road by a person carrying the mobile phone device is detected. Further, there are shown an example where transmission of information from the mobile phone device to the car navigation system is directly performed by short-distance communication means or unit between the mobile phone device and the car navigation system and an example where the transmission of the information is broadcast from a base station for the mobile phone device to the car navigation system.

However, in the prior art described before, after the person who is carrying the mobile phone device has started the crossing of the road, the action of crossing the road is detected. Thus, if the vehicle has approached the crossing person, occurrence of an accident may not be prevented even if the alarm is issued by the car navigation system. Further, when a pedestrian is walking along the road, no alarm is issued. Accordingly, especially when the driver of a vehicle has overlooked such a pedestrian during the night or the like, a risk of the traffic accident cannot be reduced.

### SUMMARY OF THE INVENTION

In view of the problems of the prior art described above, an object of the present invention is to provide a system and a method for providing information of a moving object's state of move, a location data collection system, and a car navigation system that use the car navigation system to present to the driver of a vehicle information on a location distribution, a moving speed distribution, a moving direction distribution, or a feature of a pedestrian or a vehicle, thereby enabling calling of attention to the possibility of an accident in advance.

In order to achieve the object described before, a system for providing information of a moving object's state of move according to the present invention is configured to include:

a wireless terminal device carried by a moving object and located in a predetermined area;

a wireless base station for communication with the wireless terminal device using a predetermined wireless communication channel;

a location data collection system connected to the wireless base station, for collecting data of a location where the wireless terminal device is located; and

a car navigation system mounted on a vehicle and including a communication unit, for performing communication with the wireless base station using the wireless communication channel and an output unit for presenting to a driver of the vehicle information on a guided route to a destination. Then, the system for providing information of a moving object's state of move configured as described above is characterized by operating as follows:

First, the wireless base station sends to the wireless terminal device information requesting a reply to information including the data of the location where the wireless terminal device is located. Then, the wireless base station receives information sent back by the wireless terminal device as the replay in response to the information requesting the reply, and outputs the received information to the location data collection system. Next, the location data collection system inputs the information output by the wireless base station and extracts the data of the location where the wireless terminal device is located, based on the input information. Then, the location data collection system generates state-of-move information comprising information including at least one of a location distribution, a moving speed distribution, and a moving direction distribution of the wireless terminal device and information obtained by filtering these information, based on the extracted data of the location. The location data collection system broadcasts the generated state-of-move information to the car navigation system located in the predetermined area through the wireless base station. On the other hand, the car navigation system receives the state-of move information broadcast by the location data collection system and outputs the received state-of-move information to the output unit, thereby presenting the received state-of-move information to the driver of the vehicle.

As described above, according to the present invention, the location data collection system equally collects location data of wireless terminal devices located in the predetermined area. In other words, the location data of people carrying the wireless terminal devices including a vehicle passenger and a person who is located indoors as well as a pedestrian is collected. Then, based on a result of the collection, the information such as the location distribution, moving speed distribution, and moving direction distribution is obtained. Further, the information obtained by filtering those information (hereinafter collectively referred to state-of-move information) is generated. The generated state-of-move information is sent to the car navigation system, and output to the output unit such as a display device of the car navigation system, thereby being presented to the driver of the vehicle.

Accordingly, the driver of the vehicle can know the location distribution, the moving speed distribution, and the moving direction distribution of a vehicle as well as of a pedestrian in the predetermined area including the location of his own vehicle. For this reason, the driver can grasp a state of a traffic jam or traffic congestion in the predetermined area. Accordingly, the driver can also avoid a road with an unusually great number of pedestrians, for example, where an accident tends to occur.

In the present invention, even if only one pedestrian is walking along a road, his moving speed or moving direction can be displayed. Accordingly, even in a condition such as during the night or on a left-curving road in which the pedestrian is difficult to see, the driver can readily become aware of the presence of the pedestrian.

According to the present invention, the driver of a vehicle can grasp the location and movement of a pedestrian or a vehicle in the predetermined area including the location of his own vehicle, in advance. Accordingly, at the time of driving the vehicle, the driver can early recognize the pedestrian or the like visually. Thus, the possibility of causing a traffic accident can be reduced.

### BRIEF DESCRIPTION OF THE DRAWINGS

FIG. 1 is a diagram showing an overall configuration of a system for providing information of a moving object's state of move according to an embodiment of the present invention;

FIG. 2 is a diagram showing a block configuration of a location data collection system according to the embodiment of the present invention;

FIG. 3 is a table showing configurations of records in a location data storage unit according to the embodiment of the present invention;

FIG. 4 is a table showing configurations of records in a moving information storage unit according to the embodiment of the present invention;

FIG. 5 is a table showing configurations of records in a state-of-move information storage unit according to the embodiment of the present invention;

FIG. 6 is a diagram showing a flow of information processing in the system for providing information of a moving object's state of move according to the embodiment of the present invention;

FIG. 7 is a diagram showing a flow of processing in a moving information calculating unit of the location data collection system according to the embodiment of the present invention;

FIG. 8 is a diagram showing a flow of processing in a state-of-move information generating unit of the location data collection system according to the embodiment of the present invention;

FIG. 9 is a diagram showing an example of a method for displaying a record in the state-of-move storage unit on a display screen of a car navigation system according to the embodiment of the present invention;

FIG. 10 is a diagram showing an example of a method for displaying a record in the state-of-move storage unit on the display screen of the car navigation system according to the embodiment of the present invention; and

FIG. 11 is a diagram showing an example of displaying state-of-move information on the display screen of the car navigation system according to the embodiment of the present invention.

### DESCRIPTION OF THE EMBODIMENT

An embodiment of the present invention will be described below in detail with reference to drawings.

<Overall Configuration>

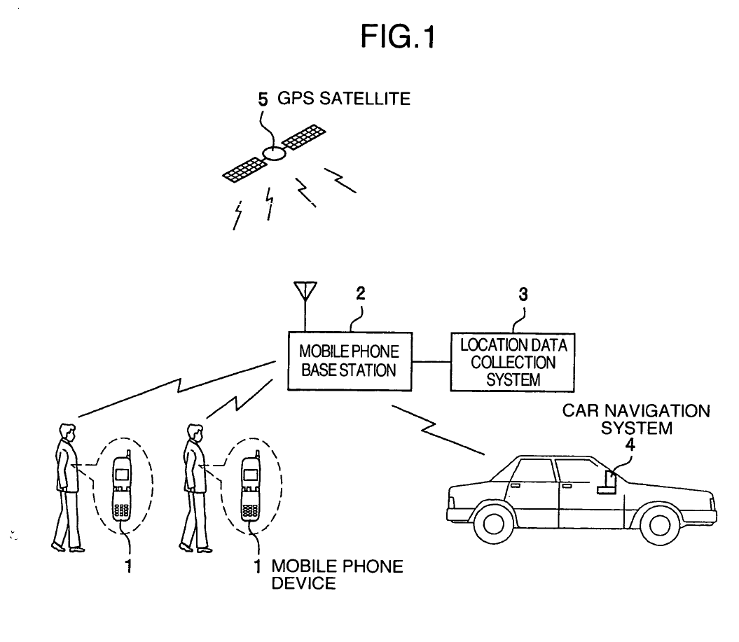

FIG. 1 is a diagram showing an overall configuration of a system for providing information of a moving object's state of move according to an embodiment of the present invention. As shown in FIG. 1, the system for providing information of a moving object's state of move according to the embodiment of the present invention is constituted by including a mobile phone device 1 carried by a moving object such as a pedestrian (set forth as a wiring terminal device in claims), a mobile phone base station 2 (set forth as a wireless base station in the claims) for performing communication with the mobile phone device 1 located in a predetermined service area using a predetermined wireless communication channel, a location data collection system 3 connected to the mobile phone base station 2, for collecting data of a location where the mobile phone device 1 is located, and a car navigation system 4 for performing communication with the mobile phone base station 2 using the predetermined wireless communication channel.

The mobile phone device 1 includes a positioning function using a GPS. By receiving an electric wave from a GPS satellite 5 as necessary, the mobile phone device 1 can detect the data of the location where the mobile phone device 1 is located. In this embodiment, the mobile phone device 1 detects the location data in response to a location data transmission request transmitted from the mobile phone base station 2, and sends back the detected location data to the mobile phone base station 2. As the mobile phone device 1 described above, a mobile phone device of a type including a GPS function that is commercially available now can be used without alteration.

The mobile phone base station 2 is provided to use a several-hundred-meter to several-kilometer square or circular area as the service area for wireless communication, and directly performs wireless communication with the mobile phone device 1 located within that service area. On the other hand, the mobile phone base station 2 is connected to a mobile phone switching station not shown, and serves to relay communication between the mobile phone device 1 and the mobile phone switching station. In this embodiment, the mobile phone base station 2 is further connected to the location data collection system 3, receives the location data of the mobile phone device 1 transmitted by the mobile phone device 1, and outputs the received location data of the mobile phone device 1 to the location data collection system 3.

The location data collection system 3 is connected to the mobile phone base station 2, inputs the location data of the mobile phone device 1 output from the mobile phone base station 2, and collects the location data of the mobile phone device 1 located in the service area of the mobile phone base station 2. The location data collection system 3 generates information on such fields as a location distribution, a moving speed distribution, and a moving direction distribution of the mobile phone device 1, and information obtained by filtering these information (information of a state of move), based on the collected location data of the mobile phone device 1. Then, the location data collection system 3 broadcasts these generated information on the state of move to the car navigation system 4 through the mobile phone base station 2.

The car navigation system 4 includes a map display unit, as in a common car navigation system, and displays a map in the vicinity of a location in which a vehicle including the car navigation system 4 is located and a guided route to a destination on the map display unit. In this case, the car navigation system 4 may be the car navigation system of an independent type including a function of computing map information and the guided route. Alternatively, the car navigation system 4 may be the car navigation system of a communication type in which the map information and the guided route are supplied from a server in a center. In this embodiment, however, it is necessary for the car navigation system 4 to enable communication with the mobile phone base station 2 using the predetermined communication channel, and to further include a function of displaying the information of the state of move.

As described above, the system for providing information of a moving object's state of move can be implemented by adding the location data collection system 3 to a mobile phone communication system and the car navigation system of (the communication type) including the conventional mobile phone device 1, mobile phone base station 2, car navigation system 4; and GPS satellite 5. Details of a configuration and an operation of the location data collection system 3 will be described below.

<Configuration and Operation of Location Data Collection System>

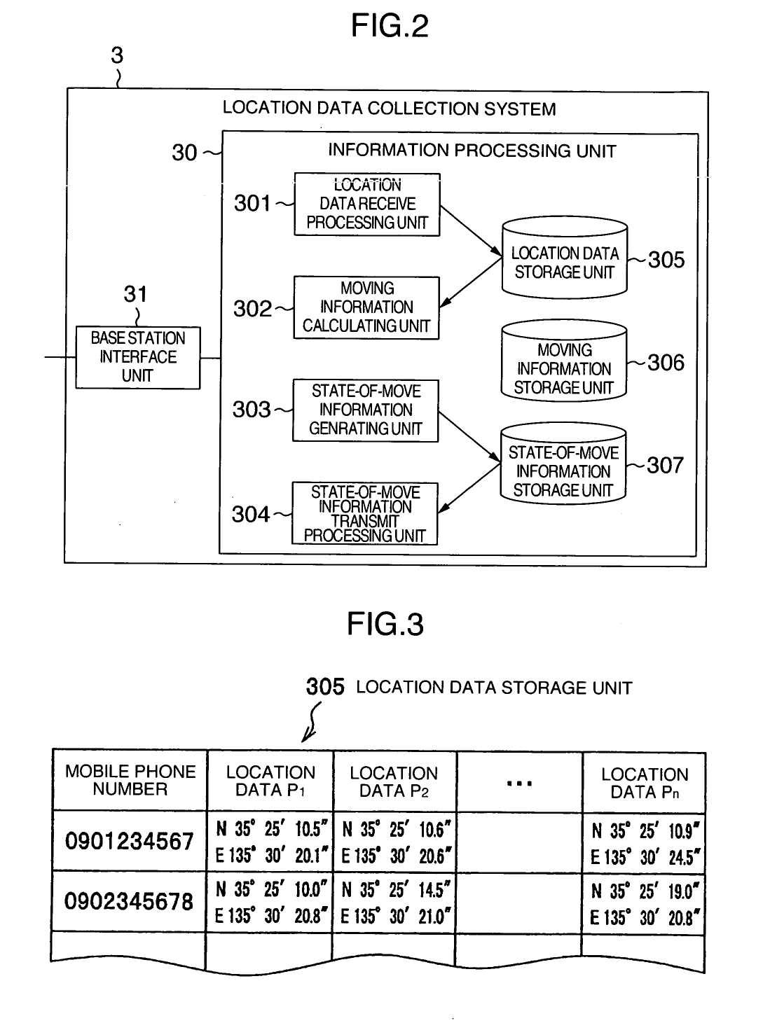

FIG. 2 is a diagram showing a block configuration of the location data collection system. As shown in FIG. 2, the location data collection system 3 is constituted by including an information processing unit 30 and a base station interface unit 31. The information processing unit 30 is further constituted by including a location data receive processing unit 301, a moving information calculating unit 302, a state-of-move information generating unit 303, a state-of-move information transmit processing unit 304, a location data storage unit 305, a moving information storage unit 306, and a state-of-move information storage unit 307.

The information processing unit 30 is a so-called computer, which is constituted from an arithmetic processing unit (CPU: central Processing Unit) not shown, and a storage unit constituted from a semiconductor memory, a hard disk drive, and the like. Then, programs to be executed by the arithmetic processing unit, information on the location data storage unit 305, moving information storage unit 306, state-of-move information storage unit 307 and the like, which have been described before, are stored in the storage unit. Functions of the location data receive processing unit 301, moving information calculating unit 302, state-of-move information generating unit 303, and state-of-move information transmit processing unit 304 are implemented by execution of the programs by the arithmetic processing unit.

The base station interface unit 31 is an interface for connecting the information processing unit 30 to the mobile phone base station 2. In this embodiment, the interface may be any interface if it enables transmission and reception of digital information between the information processing unit 30 and the mobile phone base station 2 and matches an interface on the side of the mobile phone base station 2. Accordingly, as the base station interface unit 31, a USB (Universal Serial Bus) interface, for example, can be used. Alternatively, an interface for a communication network using a TCP-IP (Transmission Control Protocol-Internet Protocol) or the like can also be used.

FIG. 3 is a table showing configurations of records in the location data storage unit. As shown in FIG. 3, a record in the location data storage unit 305 is constituted by including respective fields of a mobile phone number, location data P₁, location data P₂, . . . , and location data Pₙ. The location data P₁, location data P₂, . . . , and location data Pₙ indicate current and past location data of the mobile phone device 1 having the phone number thereof stored in the field of the mobile phone number. More specifically, the location data P₁ is the latest location data that has been just stored. The location data P₂, . . . , and location data Pₙ are the location data in the past. Incidentally, the location data is stored using latitude information and longitude information.

In the case of this embodiment, the location data receive processing unit 301 receives the location data of the mobile phone device 1 sent from the mobile phone base station 2 for each predetermined time such as each 10 seconds, and stores the received location data in the location data storage unit 305. When the fields of the location data P₁, . . . and location data Pₙ are configured to constitute an n-stage stacking structure on this occasion, the latest location data is always stored in the filed of the location data P₁. Then, in each of the fields of the location data P₂ and the location data that follow, the location data which has been sent earlier (e.g. 10 seconds earlier) than the immediately preceding location data will be stored. Accordingly, when n is set to six, for example, the current location data and the past five pieces of location data will be stored in the location data storage unit 305.

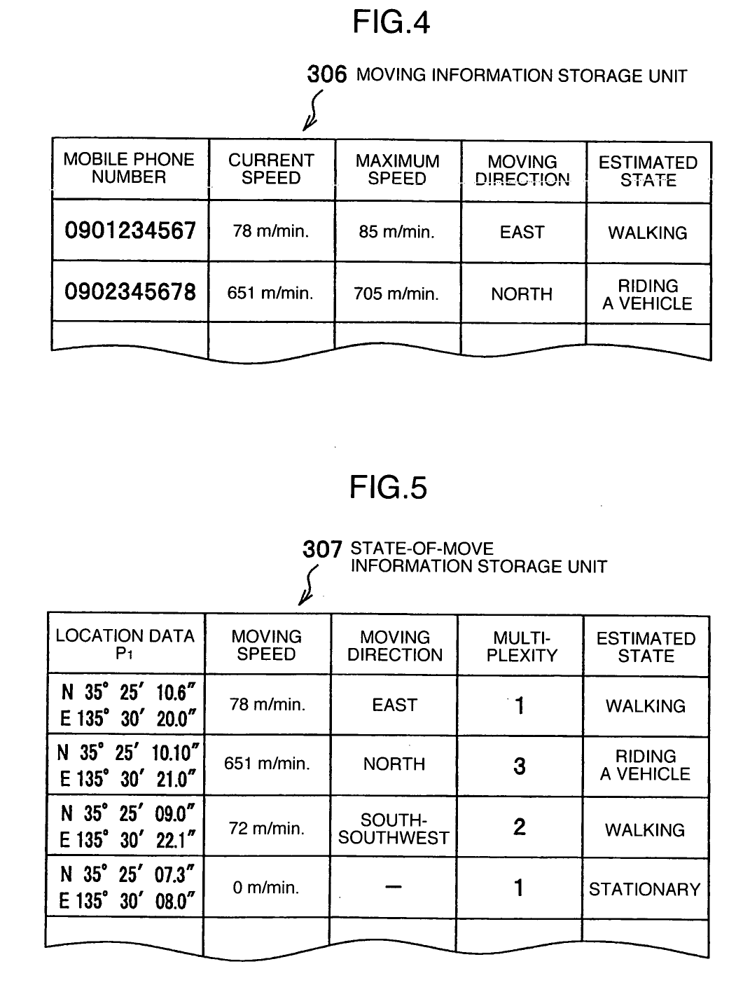

FIG. 4 is a table showing configurations of records in the moving information storage unit. As shown in FIG. 4, a record in the moving information storage unit 306 is constituted by including respective fields of the mobile phone number, a current speed, a maximum speed, a moving direction, and an estimated state of the mobile phone device 1 including the mobile phone number thereof. Values of the respective fields are calculated by the moving information calculating unit 302 based on information stored in the respective fields in the location data storage unit 305.

The current speed herein indicates a moving speed of the location data P₁ of the mobile phone device 1, or a moved distance per unit time. Accordingly, the current speed can be obtained by dividing a moved distance from the location data P₂ to the location data P₁ by a time required for the movement, such as 10 seconds.

The maximum speed indicates the maximum moving speed among moving speeds in respective locations in the past. In other words, the maximum speed refers to the maximum one obtained by dividing a moved distance from the location data Pₖ₊₁ to the location data Pₖ (in which k ranges from 2, . . . , and n−1) by a time required for the movement. Alternatively, the maximum speed may be defined to be a value obtained by comparing a value already stored in the region of the maximum speed with the value of the current speed and storing the value of the current speed in the region of the maximum speed when the value of the current speed is larger than the value already stored in the region of the maximum speed.

The moving direction can be defined to be the direction of a vector that goes from the location data P₂ to the location data P₁. Then, the direction of the vector may be represented by an angle from zero to 360 degrees with the direction of the east (in the direction of an x axis), for example, used as a reference. Alternatively, the angle may be rounded to 16 values, or quantized, and the moving direction may be represented by so-called 16 orientations.

The estimated state refers to the state of a person who is carrying the mobile phone device 1, and at least makes a distinction among a stationary person (who does not move), a pedestrian, and a vehicle passenger. When the current speed and the maximum speed of the person are both 20 m/sec. or less, for example, the person is estimated to be the stationary person. When the maximum speed of the person is 20 to 200 m/sec., for example, the person can be estimated to be the pedestrian even if the current speed of the person is 20 m/min. or less. Further, when the maximum speed of the person is larger than 200 m/min. or larger, for example, the person can be estimated to be the vehicle passenger even if the current speed of the person is 20 m/min. or less, for example.

FIG. 5 is a table showing configurations of records in the state-of-move information storage unit. As shown in FIG. 5, a record in the state-of-move information storage unit 307 is constituted by including respective fields of the location data, a moving speed, the moving direction, multiplexity, and the estimated state. Information recorded in these fields is generated by the state-of-move information generating unit 303 based on the information stored in the location data storage unit 305 and the moving information storage unit 306.

The location data herein becomes a value obtained by rounding the location data P₁ in the location data storage unit 305, or the location data included in a square of predetermined lengths becomes the same location data. Further, the values of the moving speed, the moving direction, and the like are also rounded by predetermined minimum units. Then, assuming that the mobile phone devices 1 with all the corresponding field values thereof rounded as described above being the same are moving substantially in the same manner, these mobile phone devices are brought together as one group. The number of the mobile phone devices 1 brought together as the one group is defined to be the multiplexity. For example, a record in the second column in the information storage unit 307 in FIG. 5 indicates that three vehicle passengers are moving to the north. A record in the third column indicates that two pedestrians are moving to the south-southwest.

In this embodiment, the information as described above is collected within a predetermined area. That is, the number of stationary persons, pedestrians, vehicle passengers, and the like at respective locations in the predetermined area, or densities of the respective locations are collected. Accordingly, the information stored in the state-of-move information storage unit 307 is the information obtained by unifying the information stored in the location data storage unit 305 and the moving information storage unit 306. These can be said to be the information that indicate location and speed distributions of moving objects such as a pedestrian. Then, these information is referred to as state-of-move information in this specification.

When the state-of-move information is generated in the state-of-move information storage unit 307 as described above, the generated state-of-move information is broadcast to the car navigation system 4 through the mobile phone base station 2 by the state-of-move information transmit processing unit 304.

<Flow of Operations in Overall System>

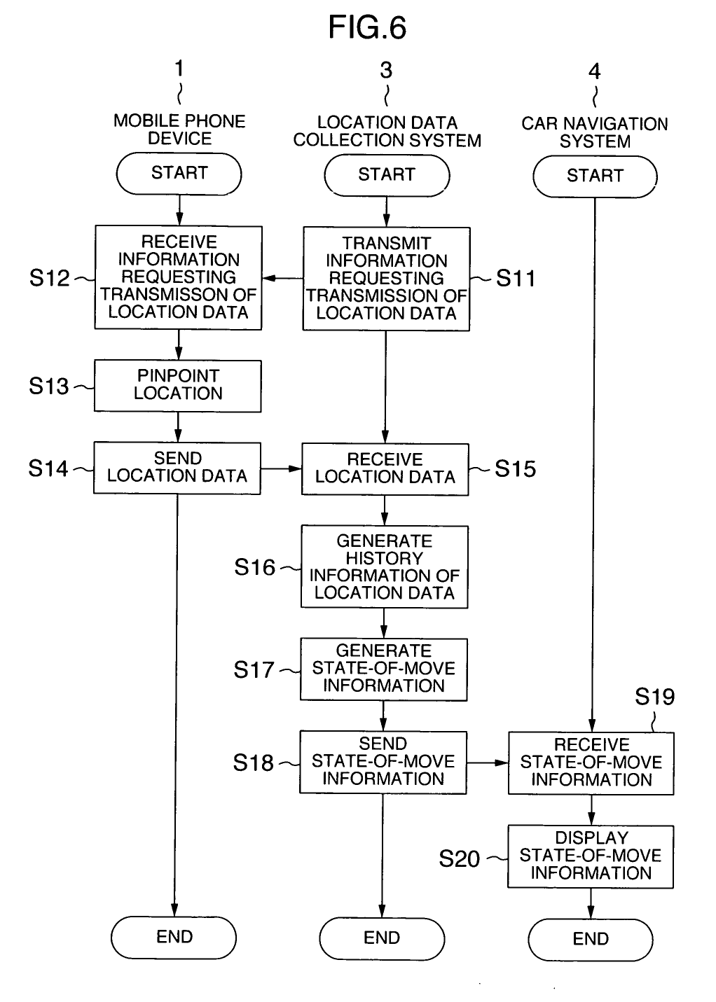

FIG. 6 is a drawing showing a flow of information processing in the system for providing information of a moving object's state of move according to the embodiment of the present invention. Referring to FIG. 6, the location data collection system 3 first sends to the mobile phone devices 1 located in the predetermined area information requesting transmission of respective location data of the mobile phone devices 1 for each predetermined time such as 10 seconds (at step S11). Incidentally, this transmission is performed from the mobile phone base station 2 to the mobile phone devices 1 in the service area thereof in the form of broadcasting.

When the mobile phone devices 1 receive the information requesting the transmission of the location data thereof (at step S12), the mobile phone devices 1 pinpoint (detect) own locations thereof based on electric waves from the GPS satellite 5 (at step S13). Then, the mobile phone devices 1 send pinpointed (detected) location data to the location data collection system 3 through the mobile phone base station 2 (at step S14).

Next, when the location data collection system 3 receives location data sent by the respective mobile phone devices 1 (at step S15), the location data collection system 3 stores the location data in the location data storage unit 305, thereby generating history information of the location data (at step S16). Then, the location data collection system 3 generates respective moving information of the mobile phone devices 1 for the moving information storage unit 306, based on the history information of the location data, and further generates the state-of-move information for the state-of-move information storage unit 307 (at step S17). Then, the location data collection system 3 sends the generated state-of-move information to the car navigation systems 4 through the mobile phone base station 2 (at step S18). Incidentally this transmission is performed from the mobile phone base station 2 to the car navigation systems 4 in the service area thereof in the form of broadcasting.

Then, each of the car navigation systems 4 receives state-of-move information transmitted from the location data collection system 3 (at step S19), and displays the received state-of-move information on a display screen of a display device constituted from an LCD (Liquid Crystal Display) or the like (at step S20). In this case, the state-of-move information or the location distribution, moving speed distribution, and moving direction distribution of the pedestrians and the like are displayed on a map indicating the vicinity of a vehicle including the car navigation system 4. An example of the display will be described later, separately.

In the flow of the information processing described above, the location data collection system 3 sends the information requesting transmission of the location data of the mobile phone devices 1. It may also be so arranged that the location data collection system 3 does not send the information requesting the transmission, and transmission of control information for confirmation of the locations of the mobile phone devices 1 in the predetermined area performed by the mobile phone base station 2 at a predetermined time interval may be substituted for the information requesting the transmission of the location data. However, in this case, when each of the mobile phone devices 1 has received the control information for the confirmation of the locations, each of the mobile phone devices 1 always needs to send back the location data obtained by a GPS electric wave or the like.

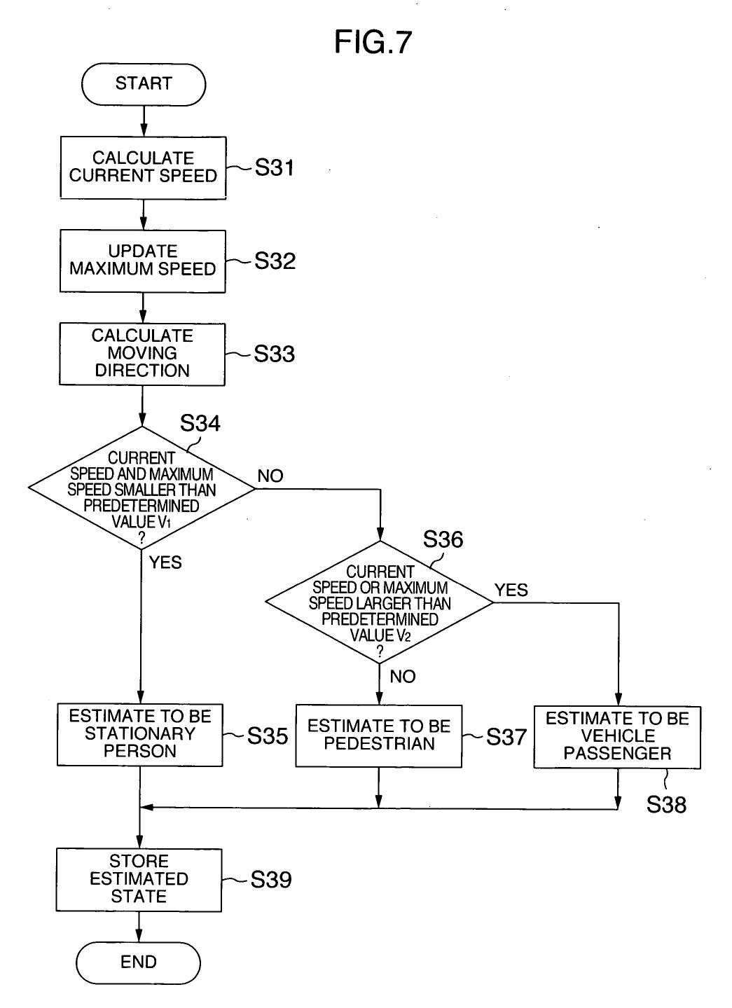

FIG. 7 is a diagram showing a flow of processing in the moving information calculating unit of the location data collection system. The flow of the processing in the moving information calculating unit 302 will be described below with reference to FIGS. 2 to 4 as well.

Referring to FIG. 7, the information processing unit 30 first refers to the current location data P₁ and the current location data P₂ in the location data storage unit 305, thereby calculating a current speed (at step S31), and stores an obtained result in the field of the current speed in the moving information storage unit 306. Next, the information processing unit 30 compares this current speed with the maximum speed already stored in the field of the maximum speed in the moving information storage unit 306. When it is found that the current speed is larger, the information processing unit 30 updates the maximum speed of the maximum speed field by the current speed (at step S32). Further, the information processing unit 30 refers to the current location data P₁ and the current location data P₂ in the location data storage unit 305, thereby calculating the moving direction (at step S33), and stores an obtained result in the field of the moving direction of the moving information storage unit 306.

Next, based on the current speed and the maximum speed obtained as described above, the information processing unit 30 estimates the state of a person who is carrying the mobile phone device 1. When it is found that the current speed and the maximum speed are both smaller than a predetermined value V₁ such as 20 m/min. (YES at step S34), the information processing unit 30 determines that the person who is carrying the mobile phone device does not move so much, and therefore estimates that the person who is carrying the mobile phone device is the stationary person (at step S35). When it is found that either the current speed or the maximum speed is the predetermined value or larger (No at step S34), the information processing unit 30 continues another determination that will be described below at step S36.

When it is found that either the current speed or the maximum speed is larger than a predetermined value V₂ (provided that the value V₂ is larger than the value V₁) such as 200 m/min. (Yes at step S36), the information processing unit 30 determines that the person who is carrying the mobile phone device is now traveling or once traveled at a speed equal to or larger than the speed of the pedestrian, and estimates the person who is carrying the mobile phone is the vehicle passenger (at step S38). When it is found that the current speed and the maximum speed are both the predetermined value V₂ such as 200 m/min. or less (No at step S36), the information processing unit 30 determines that the person who is carrying the mobile phone is the pedestrian (at step S37). Then, the information processing unit 30 stores the state of the person who is carrying the mobile phone device 1 estimated as described above in the field of the estimated state in the moving information storage unit 306 (at step S39).

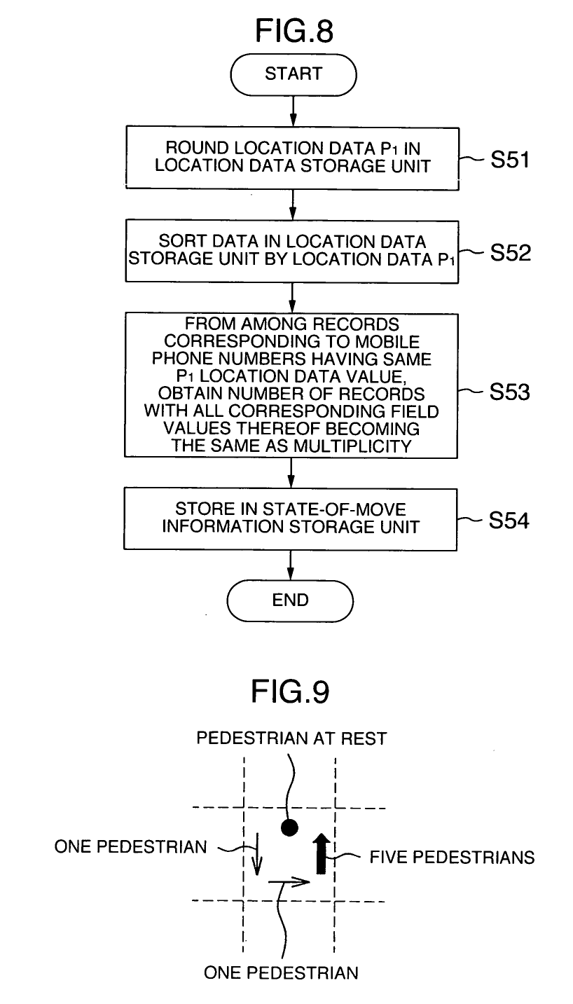

FIG. 8 is a diagram showing a flow of processing in the state-of-move information generating unit in the location data collection system. A flow of the processing in the state-of-move information generating unit 303 will be described with reference to FIGS. 2 to 5 as well.

First, the information processing unit 30 rounds the value of the location data P₁ in the location data storage unit 305 using a predetermined minimum measure (at step S51). Rounding a certain number herein refers to adjusting the number to a nearest figure on a scale in units of the predetermined minimum measure, or quantizing by the number of the minimum measure. Rounding the value of the location data to a multiple of seconds, for example, means rounding the value of the location data to the nearest second. Likewise, 0.5 second or 0.4 second may be used as the minimum measure. When the location data is represented by latitude and longitude, a difference between the one-second length of the latitude and the one-second length of the longitude increases with the latitude. Thus, the minimum measure used for the rounding may differ between the latitude and the longitude.

Next, the information processing unit 30 sorts the records in the location data storage unit 305 based on the value of the rounded location data P₁ (at step S52). Then, among the records in the moving information storage unit 306 corresponding to the mobile phone numbers with the same value of the location data P₁, the number of the records with all corresponding field values thereof becoming the same is obtained as the multiplexity (at step S53). Then, the value of the rounded location data P₁, the values of the respective fields in the moving information storage unit 306 corresponding thereto, and the multiplexity are stored in the state-of-move information storage unit 307 (at step S54).

<Examples of Display in Car Navigation System>

The information in the state-of-move information storage unit 307, generated as described above is sent to the car navigation system 4. Then, the information is displayed on the display screen of the car navigation system 4. An example of display of the state-of-move information in the car navigation system 4 will be described below.

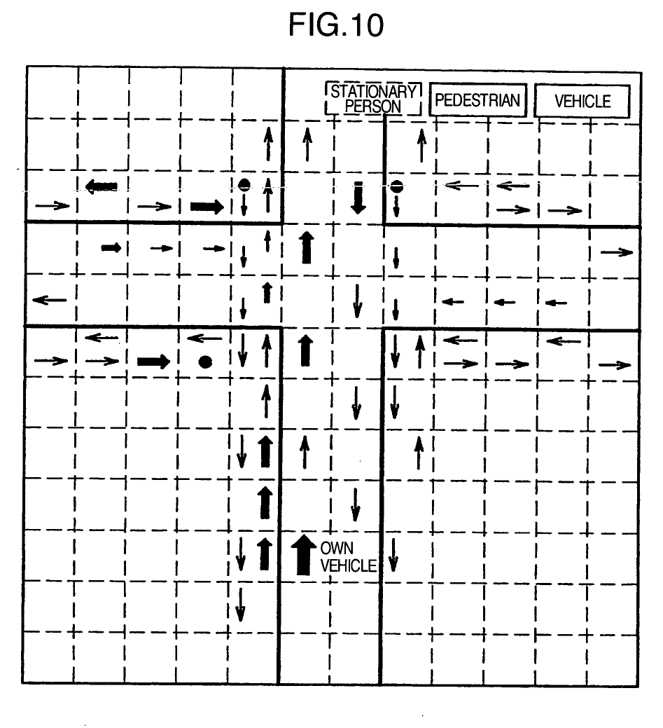

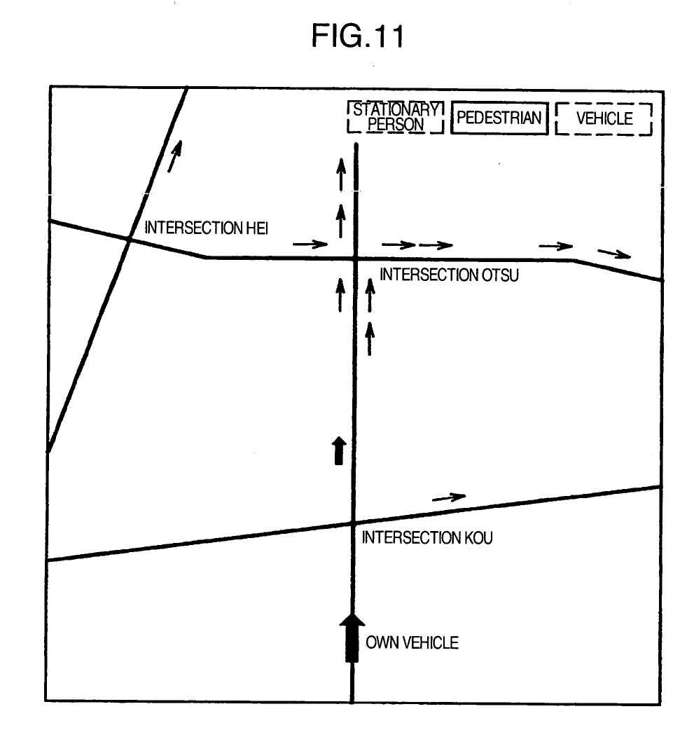

FIGS. 9 and 10 are diagrams showing examples of methods for displaying a record in the sate-of-move information storage unit on the display screen of the car navigation system. FIG. 11 is a diagram showing an example in which the state-of-move information has been displayed on the display screen of the car navigation system.

First, it is assumed herein that the state-of-move information sent from the location data collection system 3 is stored in a sate-of-move information storage unit 307′ not shown in the car navigation system 4 in the form of the information in the sate-of-move information storage unit 307 of the location data collection system 3 without alteration. Then, the car navigation system 4 reads records in the sate-of-move information storage unit 307′ one by one, and displays the information thereof on the map. The location data P₁ at that point indicates the rounded value. Thus, when its location is displayed on the map that has been enlarged, the location is displayed as a region having a certain width, such as a 5-meter square region. Then, in many cases, a plurality of pedestrians or the like will be included in the 5-meter square region.

When there are four records having the same location data P₁ in the sate-of-move information storage unit 307′, and when each of the records represents five pedestrians moving to the north (that indicates the multiplicity of five), one pedestrian at rest, one pedestrian moving to the south, and one pedestrian moving to the east, for example, those information is displayed as shown in FIG. 9. It is assumed herein that an arrow indicates a moving direction, the thickness of the arrow indicates the number of persons, and the length of the arrow indicates a moving speed. Though it is assumed herein that the number of persons such as pedestrians and the moving speed are indicated by the thickness and the length of the arrow, these may be displayed by a difference of colors, or the like for example.

As described above, display of the state-of-move information on a pedestrian or the like at a certain location becomes possible. Then, when display of the pedestrian or the like is performed on the map displayed on the display device of the car navigation system 4 according to the method of display as described above, display as shown in FIG. 10 is performed. Meshes formed by broken lines indicate regions represented by the rounded location data P₁, in which the number of pedestrians and vehicle passengers, a moving speed distribution, and a moving speed distribution are shown. Incidentally, referring to FIG. 10, the meshes do not need to be displayed in an actual display. Furthermore, in actuality, it seldom happens that lines of the meshes coincide with boundaries of roads as in the drawing. However, for convenience in description, the lines of the meshes are herein made to coincide with the boundaries of the roads and displayed.

The car navigation system 4 includes a function of filtering the information recorded in the sate-of-move information storage unit 307′, for display, as well. In the example of display in FIG. 10, three buttons indicating the “stationary person”, “pedestrian”, and “vehicle” are displayed. Herein, the buttons of the “pedestrian” and the “vehicle” are depressed. As a result, in FIG. 10, information on the “stationary person” is not displayed, so that display of only information on the “pedestrian” and the “vehicle” is performed. Incidentally, a black circle in FIG. 10 indicates the “pedestrian” who is temporarily at rest, and does not indicate the “stationary person”.

Incidentally, the “vehicle” means the vehicle passenger. Accordingly, when only the button of the “vehicle” in FIG. 10 is depressed, the location data, moving speeds, and moving directions of the mobile phone devices 1 carried by vehicle passengers on roads are displayed. Those are the same as the location data, moving speeds, and moving directions of vehicles that carry the vehicle passengers.

FIG. 11 shows the display example of pedestrians alone who have been filtered and displayed on a wider map. When information is filtered and then displayed in a manner as described above, an approximate location distribution and approximate moving directions of the pedestrians can be grasped well even by a vehicle driver. Further, when filtering of a pedestrian scurrying at a moving speed of 120 m/min. or more, or pedestrians who walk in a group of five persons or more, for example is performed and displayed, the vehicle driver will become aware of a location in which he should drive the vehicle with particular caution, in advance. In FIG. 11, for example, when the vehicle driver passes through an intersection Kou, he can immediately become aware that since a group of pedestrians walking in the same direction as his own vehicle is present, he will drive the vehicle with caution.

Further, the car navigation system 4 in this embodiment can display even one pedestrian alone. Thus, even in a condition during the night or on a left-curving road or the like, in which a front is difficult to see, presence of the pedestrian can be known in advance. As described above, according to this embodiment, a pedestrian or the like can be visually recognized at the time of driving a vehicle. Thus, the possibility of causing a traffic accident can be reduced.

### FIRST VARIATION EXAMPLE OF THE EMBODIMENT

In the embodiment described above, as shown in FIGS. 2 to 8, the location data collection system 3 performs most of the information processing associated with the location data of the mobile phone device 1, and sends resulting information thereof in the sate-of-move information storage unit 307 to the car navigation system 4. In a first variation example of this embodiment, the most of the information processing is performed by the car navigation system 4. Such a modification is possible because the car navigation system 4 also has an information processing unit including an arithmetic processing unit and a storage unit constituted from a semiconductor memory and a hard disk drive, like the location data collection system 3.

Accordingly, in this case, the location data collection system 3 temporarily stores the location data transmitted from the mobile phone device 1 located in the predetermined area, and executes only the function of broadcasting the temporarily-stored location data of the mobile phone device 1 to the car navigation system 4 through the mobile phone base station 2. The location data to be stored in this case may be the current location data alone, and the past location data does not need to be stored.

As a substitute, the car navigation system 4 needs to include a location data receive processing unit 301′ (corresponding to the location data receive processing unit 301 of the location data collection system 3 shown in FIG. 2. The same reference numeral assignment manner applies to components that will be described below), a moving information calculating unit 302′, a state-of-move information generating unit 303′, a location data storage unit 305′, a state-of-move information storage unit 306′, and a state-of-move information storage unit 307′ in the information processing unit thereof. Then, the location data receive processing unit 301′ receives the location data of the mobile phone device 1 broadcast from the mobile phone base station 2, and stores the received location data in the location data storage unit 305′. The state-of-move information calculating unit 302′ generates the moving information based on the location data storage unit 305′, and stores the generated moving information in the moving information storage unit 306′. Further, the state-of-move information generating unit 303′ generates the state-of-move information based on the location data storage unit 305′ and the moving information storage unit 306′, and stores the generated state-of-move information in the state-of-move information storage unit 307′. A flow of these processing is the same as those shown in FIGS. 7 and 8.

The information in the state-of-move information storage unit 307′ can be generated for the car navigation system 4 in a manner described above. Thus, by performing subsequent processing in manners as described with reference to FIGS. 10 and 11, the state-of-move information on a pedestrian or the like can be displayed on the display screen of the car navigation system 4. Accordingly, this first variation example of this embodiment is hardly changed from the original embodiment as seen from a vehicle driver.

In the case of the first variation example in this embodiment, the location data collection system 3 performs only the processing of temporarily storing location data sent from the mobile phone device 1 in the predetermined area. Then, the location data collection system 3 may also be constituted from a block attached to the mobile phone base station 2 rather than constituted from the information processing device including the arithmetic processing unit. In that case, the cost of an overall system can be reduced.

### SECOND VARIATION EXAMPLE OF THE EMBODIMENT

In the original embodiment described above, data of a location pinpointed based on an electric wave from the GPS satellite 5 by the mobile phone device 1 is employed as the location data of the mobile phone device 1. In this case, an error of approximately 10 to 20 meters is sometimes generated in the data of the location pinpointed. Then, in a second variation example of this embodiment, a short-range wireless communication device showing a location thereof is provided on the side of a road or the like along the road for each 10 to 20 meters, for example. The mobile phone device 1 also includes a short-range wireless communication unit capable of communicating with the short-range wireless communication device. By receiving the location data sent from the short-range wireless communication device on the side of the road, the mobile phone device 1 obtains the location data thereof. Incidentally, the mobile phone device 1 at this point may take the location data itself sent from the short-range wireless communication device on the side of the road as the location data of the mobile phone device 1. Location data obtained by correcting the location data according to the strength of the received electric wave may also be used as the location data of the mobile phone device 1. In either case, in the second variation example of this embodiment, the location data of the mobile phone device 1 is obtained by the mobile phone device 1, and the location data thereof is sent to the location data collection system 3 as the digital information.

For the short-range wireless communication device, a Bluetooth access point or an access point of a wireless LAN (Local Area Network) conforming to an IEEE 802.11 standard, or an RFID (Radio Frequency Identification) tag is used. Accordingly, in the case of the second variation example of the present invention, a factor of increasing the cost is included on the side of the mobile phone device 1. However, when an installation interval of the short-range wireless communication device is 10 to 20 meters or less, the accuracy of the data of the location pinpointed by the mobile phone device 1 will be improved in many cases.

In the second variation example of this embodiment, a timing for obtaining the location data by the mobile phone device 1 may be taken when the mobile phone device 1 receives a trigger signal from the short-range wireless communication device installed on the side of the road, rather than when the mobile phone device 1 receives the information requesting transmission of the location data from the location data collection system 3.

### THIRD VARIATION EXAMPLE OF THE EMBODIMENT

In the original embodiment described above, the mobile phone device 1 includes a unit for pinpointing its own location. When the mobile phone device 1 does not include a pinpointing unit, a third variation example of this embodiment provides unit for obtaining the location data of the mobile phone device 1.

In the third variation example of this embodiment, the mobile phone base station 2 includes antennas with directivities in respective directions of the north, south, east, and west, for example. By those antennas, a signal sent from the mobile phone device 1 is received. According to reception levels obtained from the antennas in the respective directions, the location of the mobile phone device 1 is pinpointed. When the reception levels obtained from the antennas in the east and west directions are indicated by Ex (being a positive number in the case of the east direction, and being a negative number in the case of the west direction), and when the reception levels obtained from the antenna in the south and north directions are indicated by Ey (being a positive number in the case of the north direction and being a negative number in the case of the south direction), the direction of the transmission source of the electric wave can be obtained as the direction of a vector (Ex, Ey). Further, the distance thereof can be obtained as a number inversely proportional to the magnitude of the vector (Ex, Ey). In this case, it is assumed that an inverse proportional constant is experimentally obtained in advance. In a manner as described above, the mobile phone base station 2 can obtain the direction in which the mobile phone device 1 is located and the distance of the mobile phone device 1 relative to the location of the mobile phone base station 2, so that the mobile phone base station 2 can calculate the location data of the mobile phone device 1.

In the third variation example of this embodiment, the location data collection system 3 or the mobile phone base station 2 sends (broadcasts) the information requesting transmission of the location data to the mobile phone device 1 located in the predetermined area, as in the original embodiment. The mobile phone device 1 receives the information requesting the transmission and sends predetermined dummy information. By receiving the dummy information, the mobile phone base station 2 measures the reception levels Ex and Ey. The measured reception levels are converted to the digital information by an A/D (Analog/Digital) conversion device or the like, and are output from the mobile phone base station 2 to the location data collection system 3 in the form of the values of the levels Ex and Ey. The location data collection system 3 receives the values of the levels Ex and Ey, and calculates the location data of the mobile phone device 1 based on the received Ex and Ey values. Then, the mobile phone base station 2 stores the calculated location data in the location data storage unit 305.

Incidentally, the error of the location data obtained as described above is sometimes increased. However, a location detecting unit does not need to be included in the mobile phone device 1. Thus, the cost of the mobile phone device 1 can be made to be cheap.

<Supplemental Remarks>

In the embodiment described above, the car navigation system 4 displays the state-or-move information or the information obtained by filtering the state-of-move information as display information (such as image information including a map) on the display device that the car navigation system 4 includes. The car navigation system 4 may output information to a loudspeaker as audio information, for example. However, compared with the display information, the audio information cannot represent a large quantity of information. Accordingly, in this case, the car navigation system 4 further extracts a feature of the state-of-move information or the information obtained by filtering the state-of-move information, such as information on a relationship between the location of the car navigation system 4 and the location of a pedestrian. Then, based on information on the extracted feature, the car navigation system 4 outputs an audio message such as “Several pedestrians are located 100 meters ahead”.

Further, a device for outputting the state-of-move information or the information obtained by filtering the state-of-move information by the car navigation system 4 is not limited to the display device or the loud speaker. Any device that can present at least the feature of the state-of-move information or the information obtained by filtering the state-of-move information to the driver of a vehicle including the car navigation system 4 may be employed.

1. A system for providing information of state of a moving object comprising:
a wireless terminal device carried by a moving object and located in a predetermined area;
a wireless base station for performing communication with the wireless terminal device using a predetermined wireless communication channel;
a location data collection system connected to the wireless base station, for collecting data of a location where the wireless terminal device is located; and
a car navigation system mounted on a vehicle and including communication unit, for performing communication with the wireless base station using the wireless communication channel and output unit for presenting to a driver of the vehicle information on a guided route to a destination;
wherein the wireless base station sends to the wireless terminal device information requesting a reply to information including the data of the location where the wireless terminal device is located;
the wireless base station receives information sent back by the wireless terminal device as the replay in response to the information requesting the reply, and outputs the received information to the location data collection system;
the location data collection system inputs the information output by the wireless base station and extracts the data of the location where the wireless terminal device is located, based on the input information;
the location data collection system generates state-of-move information comprising information including at least one of a location distribution, a moving speed distribution, and a moving direction distribution of the wireless terminal device and information obtained by filtering these information, based on the extracted data of the location;
the location data collection system broadcasts the generated state-of-move information to the car navigation system located in the predetermined area through the wireless base station;
the car navigation system receives the state-of move information broadcast by the location data collection system; and
the car navigation system outputs the received state-of-move information to the output unit, thereby presenting the received state-of-move information to the driver of the vehicle.

2. A system for providing information of state of a moving object comprising:
a wireless terminal device carried by a moving object and located in a predetermined area;
a wireless base station for performing communication with the wireless terminal device using a predetermined wireless communication channel;
a location data collection system connected to the wireless base station, for collecting data of a location where the wireless terminal device is located; and
a car navigation system mounted on a vehicle and including communication unit for performing communication with the wireless base station using the wireless communication channel and output unit for presenting to a driver of the vehicle information on a guided route to a destination;
wherein the wireless base station sends to the wireless terminal device information requesting a reply to information including the data of the location where the wireless terminal device is located;
the wireless base station receives information sent back by the wireless terminal device as the reply in response to the information requesting the reply, and outputs the received information to the location data collection system;
the location data collection system inputs the information output by the wireless base station and extracts the data of the location where the wireless terminal device is located, based on the input information;
the location data collection system broadcasts to the car navigation system located in the predetermined area the extracted data of the location where the wireless terminal device is located through the wireless base station;
the car navigation system receives the data of the location where the wireless terminal device is located, broadcast by the location data collection system;
the car navigation system generates state-of-move information comprising information including at least one of a location distribution, a moving speed distribution, and a moving direction distribution of the wireless terminal device and information obtained by filtering these information, based on the extracted data of the location; and
the car navigation system outputs the received state-of-move information to the output unit, thereby presenting the received state-of-move information to the driver of the vehicle.

3. The system for providing information of state of a moving object according to claim 1, wherein the information output by the wireless base station as the data indicating the location of the wireless terminal device is digital location data detected by the wireless terminal device itself and sent to the wireless base station.

4. The system for providing information according to claim 1, wherein the information output by the wireless base station as the data indicating the location of the wireless terminal device is information indicating a reception level or a reception direction when the wireless base station has received an electric wave sent by the wireless terminal device.

5. A location data collection system connected to a wireless base station for performing communication with a wireless terminal device using a predetermined wireless communication channel, for collecting data of a location where the wireless terminal device is located, wherein
the location data collection system extracts the data of the location where the wireless terminal device is located, based on information output as data indicating the location of the wireless terminal device, the information being output by the wireless base station that has received an electric wave sent from the wireless terminal device located in a predetermined area;
based on the extracted data of the location, the location data collection system generates state-of-move information comprising information including at least one of a location distribution, a moving speed distribution, and a moving direction distribution of the wireless terminal device and information obtained by filtering these information; and
the location data collection system broadcasts the generated state-of-move information to a car navigation system, the car navigation system being mounted on a vehicle located in the predetermined area and comprising communication unit for performing communication with the wireless base station using the wireless communication channel and output unit for presenting to a driver of the vehicle information on a guided route to a destination.

6. A location data collection system connected to a wireless base station for performing communication with a wireless terminal device using a predetermined wireless communication channel, for collecting data of a location where the wireless terminal device is located, wherein
the location data collection system extracts the data of the location where the wireless terminal device is located, based on information output as data indicating the location of the wireless terminal device, the information being output by the wireless base station that has received an electric wave sent from the wireless terminal device located in a predetermined area; and
the location data collection system broadcasts the extracted data of the location to a car navigation system, the car navigation system being mounted on a vehicle located in the predetermined area and comprising communication unit for performing communication with the wireless base station using the wireless communication channel and output unit for presenting to a driver of the vehicle information on a guided route to a destination.

7. The location data collection system according to claim 5, wherein the information output by the wireless base station as the data indicating the location of the wireless terminal device is digital location data detected by the wireless terminal device itself and sent to the wireless base station.

8. The location data collection system according to claim 7, wherein the digital location data sent to the wireless base station by the wireless terminal device is the data of the location calculated by reception of a GPS electric wave by the wireless terminal device.

9. The location data collection system according to claim 7, wherein the digital location data sent to the wireless base station by the wireless terminal device is the location data calculated by reception of an electric wave sent from a short-range communication base station installed in the vicinity of a road, by the wireless terminal device.

10. The location data collection system according to claim 5, wherein the information output by the wireless base station as the data indicating the location of the wireless terminal device is information indicating a reception level or a reception direction when the wireless base station has received an electric wave sent by the wireless terminal device.

11. A car navigation system mounted on a vehicle and comprising communication unit for performing communication with a wireless base station using a predetermined wireless communication channel and output unit for presenting to a driver of the vehicle information on a guided route to a destination, wherein
the car navigation system receives state-of-move information generated and broadcast by a location data collection system, the state-of move information being generated by the location data collection system based on data of a location where a wireless terminal device is located and comprising information including at least one of a location distribution, a moving speed distribution, and a moving direction distribution of the wireless terminal device and information obtained by filtering these information, the location data collection system being connected to the wireless base station, for collecting the data of the location where the wireless terminal device is located, the wireless terminal device performing communication with the wireless base station using the predetermined wireless communication channel; and
the car navigation system outputs the received state-of-move information to the output unit, thereby presenting the received state-of-move information to the driver of the vehicle.

12. A car navigation system mounted on a vehicle and comprising communication unit for performing communication with a wireless base station using a predetermined wireless communication channel and output unit for presenting to a driver of the vehicle information on a guided route to a destination, wherein
the car navigation system receives data of a location where a wireless terminal device is located, the data of the location being collected and broadcast by a location data collection system connected to the wireless base station, for collecting the data of the location, the wireless terminal device performing communication with the wireless base station using the predetermined wireless communication channel;
based on the received data of the location, the car navigation system generates state-of-move information comprising information including at least one of a location distribution, a moving speed distribution, and a moving direction distribution of the wireless terminal device and information obtained by filtering these information; and
the car navigation system outputs the generated state-of-move information to the output unit, thereby presenting the state-of-move information to the driver of the vehicle.

13. The car navigation system according to claim 11, wherein the car navigation system comprises input unit for commanding filtering processing of the state-of-move information; and
the car navigation system performs the filtering processing of the state-of-move information according to the filtering processing commanded by the input unit, and outputs the state-of-move information subjected to the filtering processing to the output unit, thereby presenting the filtered state-of-move information to the driver of the vehicle.

14. A method for providing information of state of a moving object, wherein
a wireless base station for performing communication with a wireless terminal device located in a predetermined area using a predetermined wireless communication channel, a location data collection system connected to the wireless base station, for collecting data of a location where the wireless terminal device is located, a car navigation system mounted on a vehicle and comprising communication unit for performing communication with the wireless base station using the wireless communication channel and output unit for presenting to a driver of the vehicle information on a guided route to a destination are configured to be connected to one another;
the wireless base station sends to the wireless terminal device information requesting a reply to information including the data of the location where the wireless terminal device is located;
the wireless base station receives information send back by the wireless terminal device as the reply in response to the information requesting the reply, and outputs the received information to the location data collection system;
the location data collection system inputs the information output by the wireless base station and extracts the data of the location where the wireless terminal device is located, based on the input information;
the location data collection system generates state-of-move information comprising information including at least one of a location distribution, a moving speed distribution, and a moving direction distribution of the wireless terminal device and information obtained by filtering these information, based on the extracted data of the location;
the location data collection system broadcasts the generated state-of-move information to the car navigation system located in the predetermined area through the wireless base station;
the car navigation system receives the state-of move information broadcast by the location data collection system; and
the car navigation system outputs the received state-of-move information to the output unit, thereby presenting the received state-of-move information to the driver of the vehicle.

15. A method for providing information of state of a moving object, wherein a wireless base station for performing communication with a wireless terminal device located in a predetermined area using a predetermined wireless communication channel, a location data collection system connected to the wireless base station, for collecting data of a location where the wireless terminal device is located, a car navigation system mounted on a vehicle and comprising communication unit for performing communication with the wireless base station using the wireless communication channel and output unit for presenting to a driver of the vehicle information on a guided route to a destination are configured to be connected to one another;
the wireless base station sends to the wireless terminal device information requesting a reply to information including the data of the location where the wireless terminal device is located;
the wireless base station receives information sent back by the wireless terminal device as the reply in response to the information requesting the reply, and outputs the received information to the location data collection system;
the location data collection system inputs the information output by the wireless base station and extracts the data of the location where the wireless terminal device is located, based on the input information;
the location data collection system broadcasts to the car navigation system located in the predetermined area the extracted data of the location where the wireless terminal device is located, through the wireless base station;
the car navigation system receives the data of the location where the wireless terminal device is located, broadcast by the location data collection system;
based on the extracted data of the location, the car navigation system generates state-of-move information comprising information including at least one of a location distribution, a moving speed distribution, and a moving direction distribution of the wireless terminal device and information obtained by filtering these information; and
the car navigation system outputs the received state-of-move information to the output unit, thereby presenting the received state-of-move information to the driver of the vehicle.

16. The method for providing information according to claim 14, wherein the information output by the wireless base station as the data indicating the location of the wireless terminal device is digital location data detected by the wireless terminal device itself and sent to the wireless base station.

17. The method for providing information according to claim 14, wherein the information output by the wireless base station as the data indicating the location of the wireless terminal device is information indicating a reception level or a reception direction when the wireless base station has received an electric wave transmitted by the wireless terminal device.
